(19) United States
(12) Patent Application Publication
(10) Pub. No.: US 2026/0022222 A1
(43) Pub. Date: Jan. 22, 2026

(54) MICRO-FOAMING MASTERBATCH PELLET COMPOSITIONS FOR MICRO-FOAMED PLASTICS AND METHOD OF MANUFACTURING THE SAME

(71) Applicant: Nano and Advanced Materials Institute Limited, Hong Kong (HK)

(72) Inventors: Yueying CHEN, Hong Kong (HK); Qi JIANG, Hong Kong (HK); Qi ZHU, Hong Kong (HK); Dongli SUN, Hong Kong (HK); Xianqiao LIU, Hong Kong (HK)

(21) Appl. No.: 18/777,520

(22) Filed: Jul. 18, 2024

(51) Int. Cl. C08J 9/18; C08J 9/00; C08J 9/08; C08L 23/12

(52) U.S. Cl. CPC C08J 9/18; C08J 9/0023; C08J 9/08; C08L 23/12; C08J 2201/03; C08J 2203/02; C08J 2203/22; C08J 2323/08; C08J 2323/12; C08L 2203/14; C08L 2205/025; C08L 2205/03; C08L 2207/322

(57) ABSTRACT

Provided herewith is a micro-sized foaming pellets masterbatch composition for a weight-reduced controlled micro-foaming plastic product, which includes a thermoplastic carrier resin, a bi-component micro-foaming agent comprising a gas carrier and an acid carrier, an amphiphilic stabilizing agent selected from a fatty acid-modified salt, glycerol monostearate, or a combination thereof, and an adsorbing dispersant. The masterbatch composition is compatible with a broad processing temperature range to cater to the manufacture of a wide variety of plastic types with various base plastic resins, while allowing controlled micro-sized foaming in the plastic products, thereby enabling facile manufacture of microfoam plastic products with lower weight and good mechanical strength retention with low cost, high flexibility and regulatory compliance.

### FIELD OF THE INVENTION

The invention relates to the technical field of micro-foam plastic manufacture. In particular, it relates to a micro-sized foaming pellets masterbatch composition for a weight-reduced plastic product, in which controllable micro-foaming is achieved.

### BACKGROUND OF THE INVENTION

Plastic foams are polymers with internal spaces and cells that are frequently utilized in plastic for their lightweight, inexpensive, and thermally insulating properties. Foaming materials have a microporous internal structure with countless air bubbles or pores inside them and can also be regarded as composite materials with gas as filler. Polymer foam materials come in a wide variety. High temperature processing plastic foams include polyethylene terephthalate (PET) foam, polyamide 6 (PA6) foam, acrylonitrile butadiene styrene (ABS) foam, polycarbonate (PC) foam, and other plastic foam that are widely used in plastic industry such as packaging, medical devices, vehicles, sports ware, toys and consumables. With the vast variety of applications across different fields, the market size of plastic foams is immense and constantly expanding, amounting to USD 52.3 billion in 2019 and projected to be USD 86.9 billion in 2027.

Among plastic foams, micro-foamed plastic products are emerging and gaining increasing attention for its desired features of light weight, plastic raw material reduction, carbon reduction and thermal insulation.

Foamed plastic is usually prepared by extrusion foaming, foam injection molding, or bead foaming. The polymer resin is fed into an extruder or molding machine and undergoes a series of reactions to form the final product. When manufacturing foamed plastic products, distribution of pores and pore size strongly affects mechanical strength and weight reduction of the foamed plastics, especially under high injection molding temperature.

Current micro-foaming technologies for plastics are generally classified into physical foaming and chemical foaming. Physical foaming, e.g. MuCell®, while capable of forming micro-sized foaming pores of 50 μm-150 μm, retaining good mechanical strength and is highly compliant with regulations, has a major drawback of high cost due to the need of specialized equipment.

On the other hand, chemical foaming, e.g. through the use of azodicarbonamide (AC) foaming agent, is advantageous in terms of being compatible to a broad range of foaming processing temperature (180° C.-250° C.), while having a high foaming efficiency and relatively low cost. However, the major limitation of chemical foaming is that the foaming gas/pore sizes are uncontrollable, which may result in a significantly weakening of mechanical strength (a >60% drop in comparison with the control), and hence also a rough surface and unappealing appearance. Also, there may be regulatory compliance issues in relation to the usage of chemical foaming agents.

As such, there is a need to develop a novel foaming technology which allows controllable and stable micro-sized foaming pores formation in a plastic foam with a reasonable cost, while ensuring regulatory compliance of the micro-sized foaming process. The present invention addresses this need.

### SUMMARY OF THE INVENTION

This section is for the purpose of summarizing some aspects of embodiments of the invention and to briefly introduce some further embodiments. In this section, as well as in the abstract and the title of the invention of this application, simplifications or omissions may be made to avoid obscuring the purpose of the section, the abstract and the title, and such simplifications or omissions are not intended to limit the scope of the invention.

The present invention has been made in view of the above-mentioned problems of the need of an improved foaming technology for producing micro-foaming plastic products with controllable micro-sized foaming pores which retains good mechanical strength, while maintaining at a reasonable cost level and a safe and regulation-compliant manufacturing process.

Accordingly, one aspect of the present invention provides a micro-sized foaming pellets masterbatch composition for a weight-reduced controlled micro-foaming plastic product, which includes a low-melting point thermoplastic carrier resin, a bi-component micro-foaming agent comprising a gas carrier and an acid carrier, an amphiphilic stabilizing agent selected from a fatty acid-modified salt, glycerol monostearate, or a combination thereof, and an adsorbing dispersant. The micro-sized foaming pellets masterbatch composition is specifically configured to be integrated into a weight-reduced controlled micro-foaming plastic product, by mixing the masterbatch composition with a base plastic resin and subjecting to extrusion and injection molding to create a foamed plastic, such that the micro-sized foaming pellets masterbatch induces a tunable density of nucleation to the base plastic resin to form the weight-reduced controlled micro-foaming plastic product. The resulting weight-reduced controlled micro-foaming plastic product has a weight at least 9% lower than a plastic product prepared without integrating the micro-sized foaming pellets masterbatch composition, and at least 75% of the tensile strength and 95% of the flexural modulus of a plastic product prepared without integrating the micro-sized foaming pellets masterbatch composition is retained in the weight-reduced controlled micro-foaming plastic product. 90% of the pores of the weight-reduced controlled micro-foaming plastic product also has a pore size of less than 150 μm.

The gas carrier and the acid carrier of the bi-component micro-foaming agent are in weight ratios of 3%-15% and 15-50% respectively, relative to the bi-component micro-foaming agent.

In a further embodiment of the present invention, the low-melting point thermoplastic carrier resin has a melting of below 125° C., and is selected from linear low-density polyethylene (LLDPE), low-density polyethylene (LDPE), ethylene methyl acrylate (EMA), ethylene vinyl acetate (EVA), or any combinations thereof.

In a further embodiment of the present invention, the gas carrier of the bi-component micro-foaming agent is selected from sodium bicarbonate, ammonium carbonate, or a combination thereof.

In a further embodiment of the present invention, the acid carrier of the bi-component micro-foaming agent is selected from citric acid, sodium dihydrogen citrate, sodium dihydrogen phosphate, or any combinations thereof.

In a further embodiment of the present invention, the fatty acid-modified calcium carbonate is selected from oleic acid-modified calcium carbonate, stearyl phosphate-modified calcium carbonate, palmitic acid-modified calcium carbonate, stearic acid-modified calcium carbonate, or any combinations thereof.

In a further embodiment of the present invention, the adsorbing dispersant is mineral oil.

In a further embodiment of the present invention, the content of the low-melting point thermoplastic carrier resin ranges from 50 wt % to 90 wt %.

In a further embodiment of the present invention, the content of the bi-component micro-foaming agent ranges from 10 wt % to 50 wt %.

In a further embodiment of the present invention, the content of the amphiphilic stabilizing agent ranges from 1 wt % to 10 wt %.

In a further embodiment of the present invention, the content of the dispersant ranges from 0.5 wt % to 10 wt %.

In another aspect of the present invention, a method of preparing a weight-reduced controlled micro-foaming plastic product with the above-mentioned micro-sized foaming pellets masterbatch composition is provided, comprising mixing a low-melting point thermoplastic carrier resin, a bi-component micro-foaming agent, an amphiphilic stabilizing agent and a dispersant to form a first mixture; subjecting the first mixture to extrusion and pelletizing the first mixture at a temperature of 60° C. to 150° C. to form the micro-sized foaming pellets masterbatch composition; mixing the micro-sized foaming pellets masterbatch composition with base plastic resins to form a second mixture; and subjecting the second mixture to extrusion and molding the second mixture at a temperature of 220° C. to 300° C. rpm to form the weight-reduced controlled micro-foaming plastic product.

In a further embodiment of the second aspect of the present invention, the subjecting the first mixture to extrusion and pelletizing the first mixture comprises extrusion under a screw rotation speed of 140 rpm to 160 rpm.

In a further embodiment, the subjecting the second mixture to extrusion and molding the second mixture comprises extrusion under a screw rotation speed of 90 rpm to 110 rpm.

In a further embodiment, the micro-sized foaming pellets masterbatch composition comprises 60 wt % to 88 wt % of the low-melting point thermoplastic carrier resin, 20 wt % to 40 wt % of the micro-foaming agent, 1 wt % to 3 wt % of the adsorbing dispersant and 5 wt % to 9 wt % of the amphiphilic stabilizing agent.

In a further embodiment of the second aspect, the low-melting point thermoplastic carrier resin is selected from linear low-density polyethylene (LLDPE), low-density polyethylene (LDPE), ethylene methyl acrylate (EMA), ethylene vinyl acetate (EVA), or any combinations thereof.

In a further embodiment of the present invention, the gas carrier of the bi-component micro-foaming agent is selected from sodium bicarbonate, ammonium carbonate, or a combination thereof.

In a further embodiment of the second aspect, the acid carrier of the bi-component micro-foaming agent is selected from citric acid, sodium dihydrogen citrate, sodium dihydrogen phosphate, or any combinations thereof.

In a further embodiment of the second aspect, the fatty acid-modified calcium carbonate is selected from oleic acid-modified calcium carbonate, stearyl phosphate-modified calcium carbonate, palmitic acid-modified calcium carbonate, stearic acid-modified calcium carbonate, or any combinations thereof.

In a further embodiment of the second aspect, the adsorbing dispersant is mineral oil.

In a further embodiment of the second aspect, the base plastic resins is selected from polyethylene (PE), polypropylene (PP), polyethylene terephthalate (PET), polyamide 6 (PA6), acrylonitrile butadiene styrene (ABS), polycarbonate (PC), or any combinations thereof.

### BRIEF DESCRIPTION OF THE DRAWINGS

In order to more clearly illustrate the technical solutions of the embodiments of the present invention, the drawings needed to be used in the description of the embodiments will be briefly introduced below. It is obvious that the drawings in the following description are only some embodiments of the present invention, and it is obvious for those skilled in the art to obtain other drawings based on these drawings without inventive exercise, in which:

FIG. 1 is a schematic diagram of the controlled micro-sized foaming mechanism in the microfoam plastic product utilizing the micro-sized foaming pellets masterbatch composition of the present invention.

FIG. 2 shows the chemical reaction under which the gas carrier and the acid carrier of the bi-component microfoaming agent reacts under heating to produce foams.

FIG. 3 is a schematic diagram of the formation of the micro-sized foaming pellets masterbatch composition of the present invention.

FIG. 4 is a schematic diagram showing the formation of weight-reduced controlled micro-foaming plastic product through the mixing of micro-sized foaming pellets masterbatch composition and base plastic resin and subsequent processing.

FIGS. 5A-5C, FIGS. 6A-6C and FIGS. 7A-7C show the experimental results of investigating the effects of different amphiphilic stabilizing agents in the micro-sized foaming pellets masterbatch composition on the pore size of the microfoam plastic product, with the loading amounts of foaming agents being the same, and ethylene methyl acrylate (EMA) chosen as the thermoplastic carrier resin.

FIGS. 5A-5C show the external appearance (FIG. 5A) the scanning electron microscopy image (FIG. 5B, magnification 50×) and distribution of pore sizes (FIG. 5C) of the plastic product without using any amphiphilic stabilizing agents.

FIGS. 6A-6C show the external appearance (FIG. 6A) the scanning electron microscopy image (FIG. 6B, magnification 50×) and distribution of pore sizes (FIG. 6C) of the plastic product with fatty acid-modified calcium carbonate chosen as the amphiphilic stabilizing agent.

FIGS. 7A-7C show the external appearance (FIG. 7A) the scanning electron microscopy image (FIG. 7B, magnification 50×) and distribution of pore sizes (FIG. 7C) of the plastic product with glycerol monostearate chosen as the amphiphilic stabilizing agent.

FIG. 8 shows the photographs of plastic products formed with using the micro-sized foaming pellets masterbatch composition of the present invention (uppermost); using 4 wt % MFP-01 #micro-sized foaming pellets masterbatch composition (second uppermost); using 4 wt % MFP-04 #micro-sized foaming pellets masterbatch composition (second lowest) and using 4 wt % MFP-05 #micro-sized foaming pellets masterbatch composition (lowest) respectively, subjected to tensile strength test. The results are shown in Table 3.

FIG. 9 shows the photographs of plastic products formed with using the micro-sized foaming pellets masterbatch composition of the present invention (uppermost); using 4 wt % MFP-01 #micro-sized foaming pellets masterbatch composition (second uppermost); using 4 wt % MFP-04 #micro-sized foaming pellets masterbatch composition (second lowest) and using 4 wt % MFP-05 #micro-sized foaming pellets masterbatch composition (lowest) respectively, subjected to flexural modulus test. The results are shown in Table 4.

### DETAILED DESCRIPTION OF THE INVENTION

In order to make the aforementioned objects, features and advantages of the present invention comprehensible, embodiments accompanied with figures are described in detail below.

In the following description, numerous specific details are set forth in order to provide a thorough understanding of the present invention, but the present invention may be practiced in other ways than those specifically described and will be readily apparent to those of ordinary skill in the art without departing from the spirit of the present invention, and therefore the present invention is not limited to the specific embodiments disclosed below.

The present invention provides a micro-sized foaming pellets masterbatch composition, configured to be integrated to create a weight-reduced controlled micro-foaming product by mixing the masterbatch composition with a base plastic resin through extrusion and injection molding.

The micro-sized foaming pellets masterbatch composition comprises a low-melting point thermoplastic carrier resin, a bi-component micro-foaming agent comprising a gas carrier and an acid carrier, an amphiphilic stabilizing agent selected from a fatty acid-modified salt, glycerol monostearate, or a combination thereof, and an adsorbing dispersant. The gas carrier is a bicarbonate-based salt, and the acid carrier is selected from citric acid, sodium dihydrogen citrate, sodium dihydrogen phosphate or any combinations thereof. Specifically, the gas carrier in the composition is added in excess, the excess of which act as nucleator to trap in-situ foaming gas for a uniform bubble distribution.

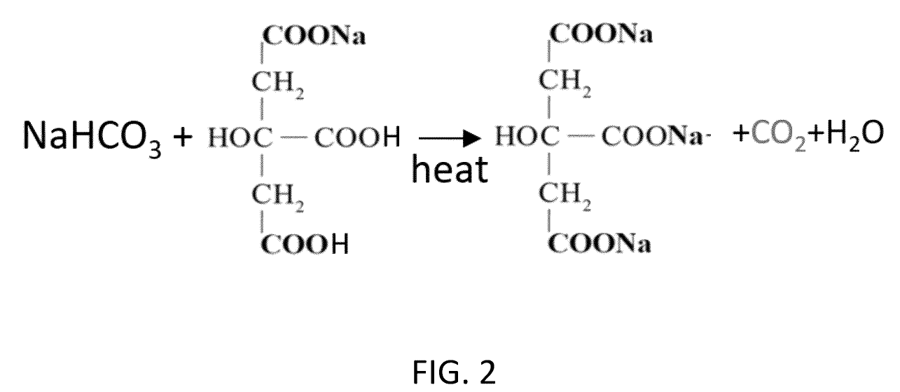

As seen in the chemical equation of FIG. 2, with sodium bicarbonate and sodium dihydrogen citrate chosen as an example, when the mixture of the two are heated, carbon dioxide as the foaming gas is formed.

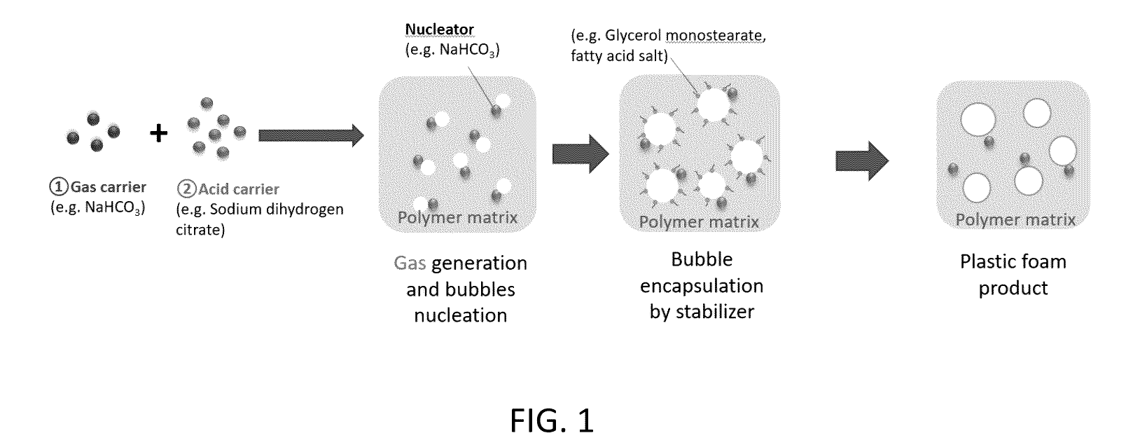

Referring back to FIG. 1, the carbon dioxide gas generated will form bubbles with the aid of excess gas carriers as nucleator molecules in the base plastic resin-masterbatch matrix. The formed bubbles are then encapsulated by the stabilizing agents.

A distinct feature of the present invention is that the stabilizing agents chosen in this present invention, i.e. glycerol monostearate, fatty acid-modified calcium carbonate (oleic acid-modified calcium carbonate, stearyl phosphate-modified calcium carbonate, palmitic acid-modified calcium carbonate, stearic acid-modified calcium carbonate), or any combinations thereof, are all amphiphilic in nature, meaning that they all possess a hydrophilic head which can be compatible and soluble in aqueous solutions, and a hydrophobic hydrocarbon tail which is organic solvent-soluble. Advantageously, the amphiphilicity of the stabilizing agents allow them to encapsulate the bubbles, promoting uniform distribution and dispersion of the bubbles into micro-pores while preventing the bubbles from aggregating. Therefore, this may also enhance the nucleation density in the weight-reduced controlled micro-foaming product, hence also a weight of the plastic product being at least 9% lower than a plastic product prepared without integrating the micro-sized foaming pellets masterbatch composition, and a considerable mechanical strength with at least 75% of the tensile strength and at least 95% of the flexural modulus of a plastic product prepared without integrating the micro-sized foaming pellets masterbatch composition being retained in the plastic product.

Beneficially, the micro-sized foaming pellets masterbatch composition can be produced with a relatively low cost and be regulation-compliant through the selection of common commercial food grade ingredients as the thermoplastic carrier resins of the micro-sized foaming pellets masterbatch composition. Examples include, but are not limited to linear low-density polyethylene (LLDPE), low-density polyethylene (LDPE), ethylene methyl acrylate (EMA), ethylene vinyl acetate (EVA), etc.

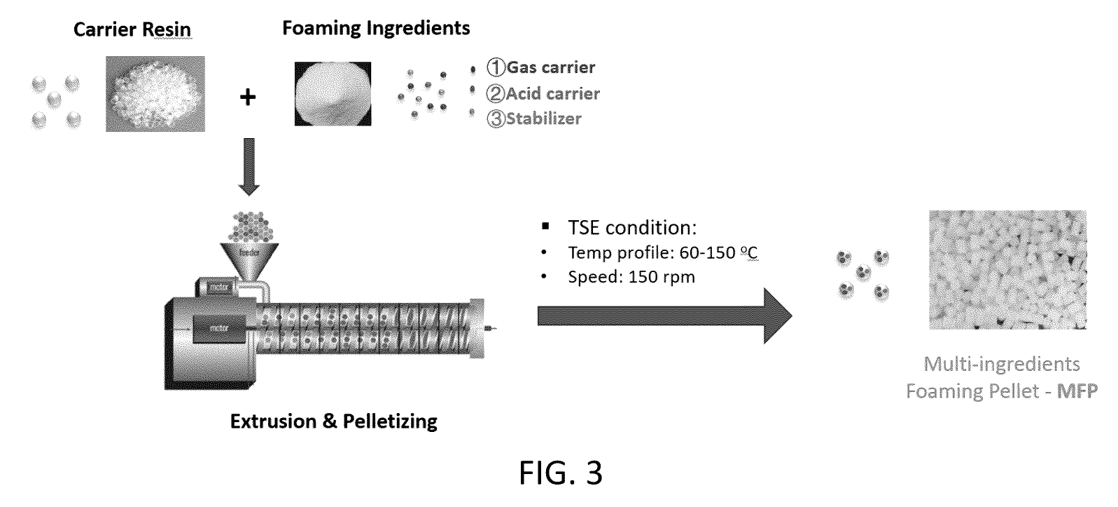

Turning to FIG. 3, the micro-sized foaming pellets masterbatch composition can be easily formed through simple mixing of the thermoplastic carrier resin, the bi-component foaming agent, the disperser and the amphiphilic stabilizing agents, and subjecting the mixture to extrusion and pelletizing in a twin-screw extruder under a temperature of 60° C. to 150° C. with a preferred screw rotation speed of 150 rpm.

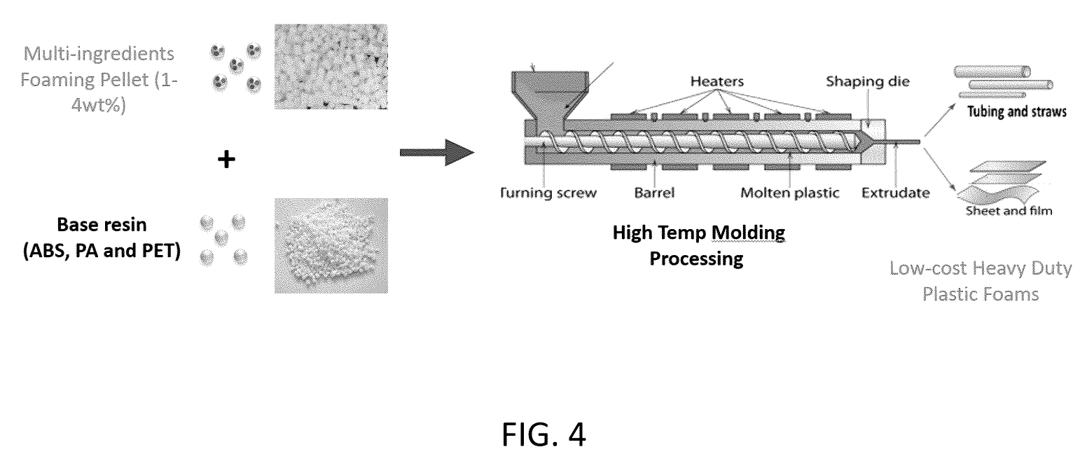

With reference to FIG. 4, the micro-sized foaming pellets masterbatch composition is mixed with a wide variety of base plastic resins selected from polyethylene (PE), polypropylene (PP), polyethylene terephthalate (PET), polyamide 6 (PA6), acrylonitrile butadiene styrene (ABS), polycarbonate (PC), etc. A preferred weight ratio of the micro-sized foaming pellets to the base plastic resin is 1:99 to 4:96. The masterbatch-base resin mixture can then be subjected to high-temperature extrusion and molding to form a weight-reduced controlled micro-foaming product. In general, the processing temperature ranges from 220° C. to 330° C., and the preferred screw rotation speed is 100 rpm.

Another advantage of the present invention is that, given the compatibility of the micro-sized foaming pellets masterbatch composition with a broad processing temperature range, by selecting the respective ingredients, a wide variety of plastic types can be manufactured, for example acrylonitrile butadiene styrene (ABS) under a processing temperature range of 220° C. to 240° C., polyamide 6 under a processing temperature range of 240° C. to 260° C., and polyethylene terephthalate (PET) under a processing temperature range of 260° C. to 300° C. for twin-screw extrusion respectively.

### EXAMPLES

To investigate the effect of adopting different amphiphilic stabilizing agents in the micro-sized foaming pellets masterbatch composition on the pore sizes, tensile strength and flexural moduli of the plastic products, tests are conducted with the different components as shown in Table 1.

TABLE 1

| Micro-sized | | | | Amphiphilic stabilizing | |
|---|---|---|---|---|---|
| foaming | | Foaming agents | | agent | |
| pellets | | Sodium | | Fatty acid- | |
| masterbatch | Carrier | dihydrogen | Sodium | modified | Glycerol |
| composition | resin | citrate | bicarbonate | CaCO₃ | monostearate |
| MFP-01# | Ethylene | 10-20% | 1-10% | — | — |
| MFP-04# | methyl | | | √ | |
| MFP-05# | acrylate | | | | √ |
| | (EMA) | | | | |

It should be noted that in all MFP-01 #, MFP-04 #and MFP-05 #, the loading amounts of the foaming agents are identical; and the plastic samples are formed with 4% loading of MFP-01 #, MFP-04 #and MFP-05 #respectively.

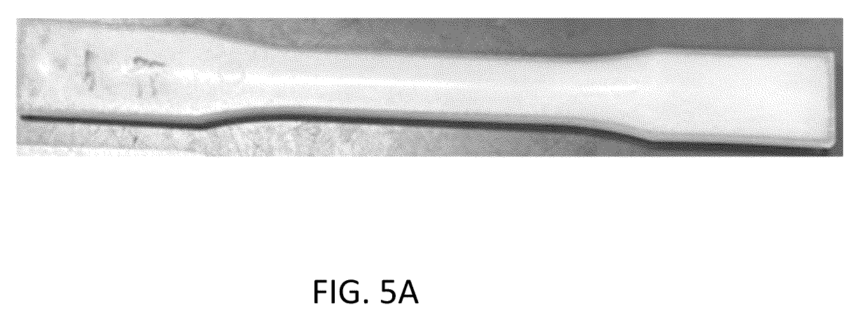

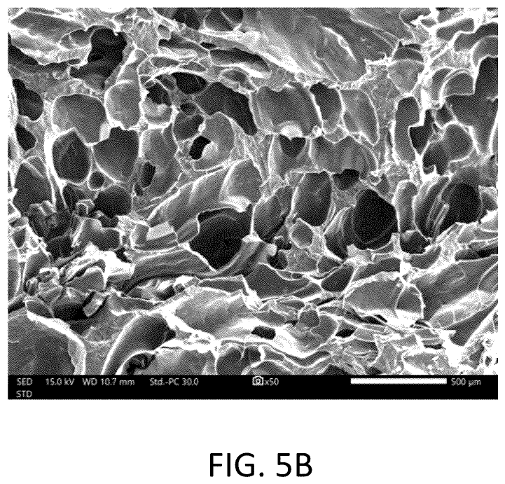

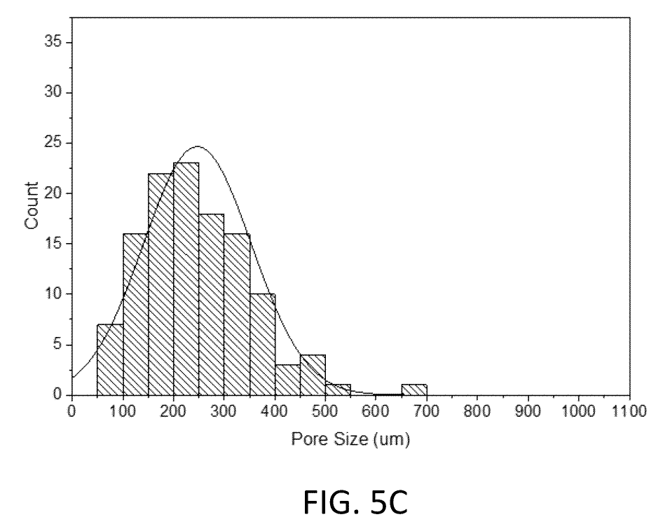

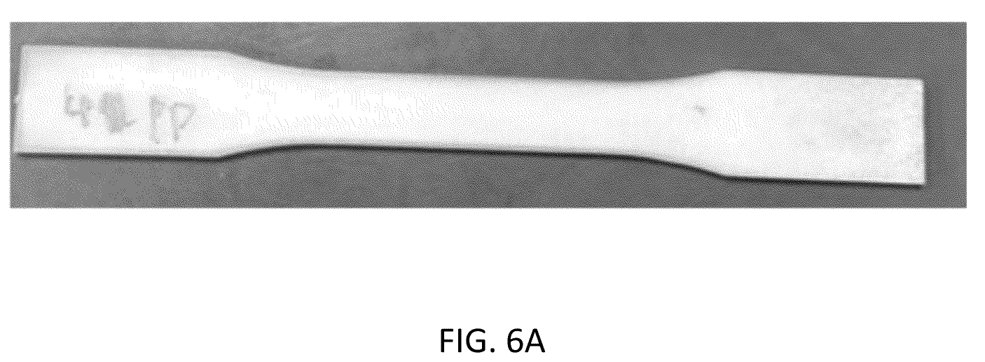

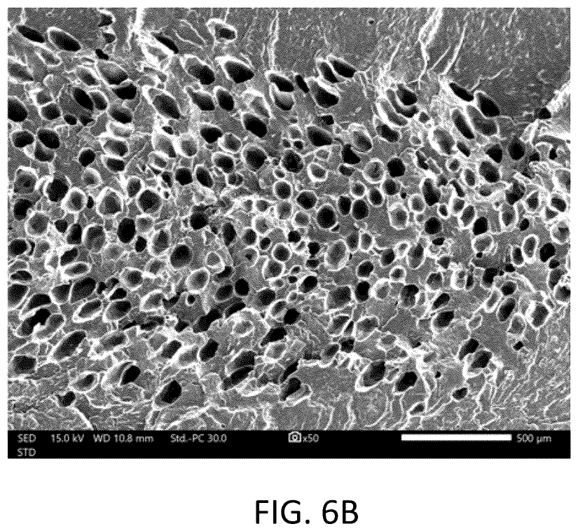

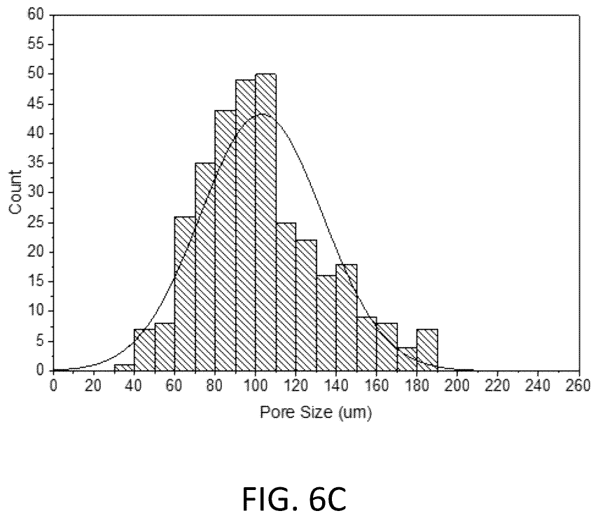

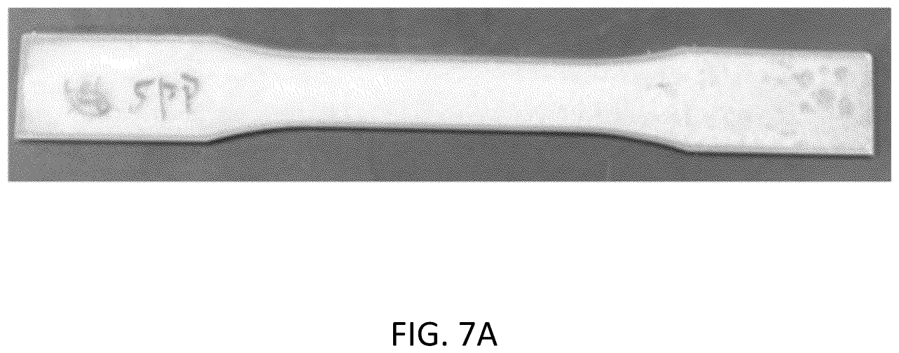

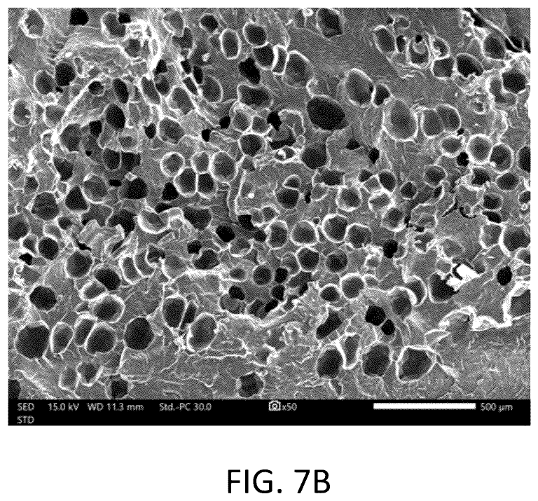

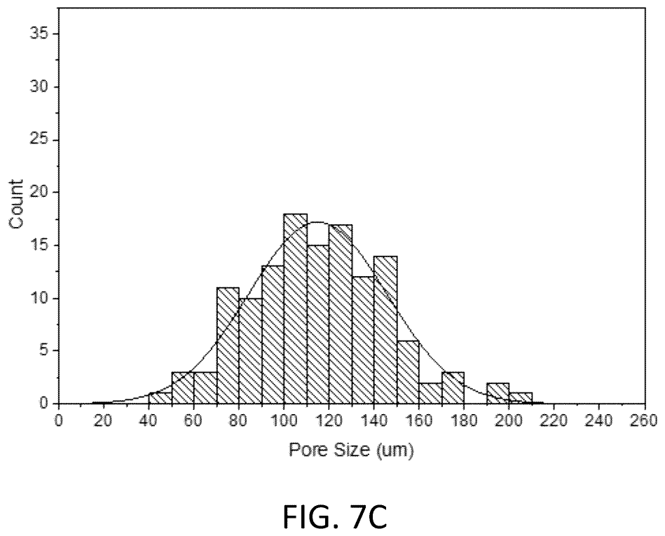

The appearances of the plastic samples manufactured by mixing MFP-01 #, MFP-04 #and MFP-05 #as the micro-sized foaming pellets masterbatch composition with EMA base plastic resins are shown in FIGS. 5A, 6A and 7A respectively.

By comparing the scanning electron microscopy images of the plastic samples manufactured by mixing MFP-01 #, MFP-04 #and MFP-05 #as the micro-sized foaming pellets masterbatch composition with EMA base plastic resins, which are shown in FIGS. 5B, 6B and 7B, it is observed that with an amphiphilic stabilizing agent added (as in MFP-04 #and MFP-05 #), the pore sizes are significantly smaller, and a higher nucleation density can also be observed.

FIGS. 5C, 6C and 7C show the distribution of the pore sizes in the plastic samples incorporating MFP-01 #, MFP-04 #and MFP-05 #respectively.

A further calculation of the number of pores in the plastic products, the average pore size and percentage of pores of sizes within 20 μm-150 μm are tabulated in Table 2 below.

TABLE 2

| | | Average | % of pores of |
|---|---|---|---|
| Plastic | Number | pore size | sizes within |
| sample | of pores | (μm) | 20 μm-150 μm |
| MFP-01# | 121 | 247.0 ± 106.8 | 19.0% |
| MFP-04# | 329 | 103.0 ± 30.3 | 91.5% |
| MFP-05# | 180 | 114.9 ± 30.6 | 90.1% |

It is therefore concluded that, with the addition of amphiphilic stabilizing agents, the number of pores (and hence nucleation density) is significantly increased in the plastic product, with the average microfoam sizes also approximately halved.

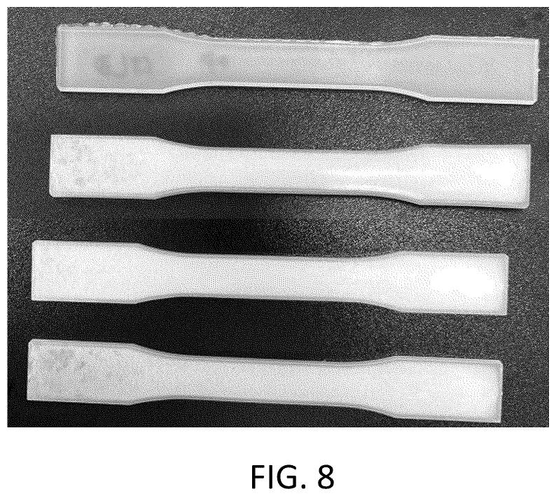

Further tests are conducted with polypropylene (PP)-based plastic samples incorporating MFP-01 #, MFP-04 #and MFP-05 #respectively (and a control without incorporating any masterbatch compositions) to investigating their tensile strengths. FIG. 8 shows the photographs showing the plastic samples subjected to the tensile strength test.

Accordingly, the results of the tensile strength tests of the plastic samples are tabulated in Table 3 below.

TABLE 3

| | | | Micro-sized foaming pellets | | | | Tensile |
|---|---|---|---|---|---|---|---|
| | Base | | masterbatch composition | | | Weight | strength |
| Sample | resin | | MFP-01# | MFP-04# | MFP-05# | (g) | (MPa) |
| Control | 100% | PP | — | — | — | 7.57 ± 0.06 | 31.6 ± 0.6 |
| PP-MFP- | 96% | PP | 4% | — | — | 6.23 ± 0.12 | 18.1 ± 2.2 |
| 01# | | | | | | | |
| PP-MFP- | 96% | PP | — | 4% | — | 6.20 ± 0.10 | 24.7 ± 1.3 |
| 04# | | | | | | | |
| PP-MFP- | 96% | PP | — | — | 4% | 6.23 ± 0.15 | 24.1 ± 0.3 |

05#

Taking the control as a baseline reference, it is observed that the weight of all plastic samples with micro-sized foaming pellets masterbatch composition incorporated demonstrate a 17%-18% drop in weight. However, while PP-MFP-01 #(i.e. masterbatch without amphiphilic stabilizing agents) shows an over 40% drop in tensile strength compared with the control, for PP-MFP-04 #and PP-MFP-05 #(i.e. masterbatch with amphiphilic stabilizing agents), both retained more than 75% of the tensile strength.

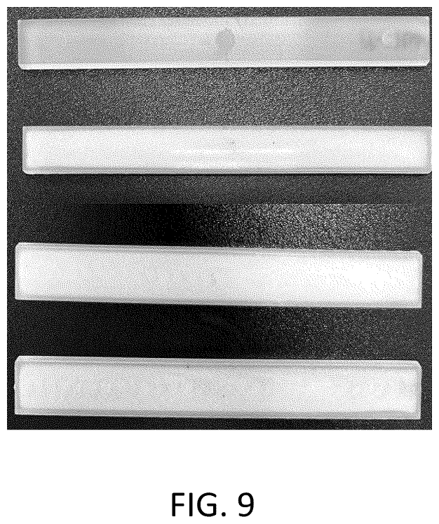

A similar test is conducted with polypropylene (PP)-based plastic samples incorporating MFP-01 #, MFP-04 #and MFP-05 #respectively (and a control without incorporating any masterbatch compositions) to compare their flexural moduli. FIG. 9 shows the photographs showing the plastic samples subjected to the tensile strength test.

Accordingly, the results of the flexural moduli tests of the plastic samples are tabulated in Table 4 below.

TABLE 4

| | | | Micro-sized foaming pellets | | | | Flexural |
|---|---|---|---|---|---|---|---|
| | Base | | masterbatch composition | | | Weight | modulus |
| Sample | resin | | MFP-01# | MFP-04# | MFP-05# | (g) | (MPa) |
| Control | 100% | PP | — | — | — | 4.57 ± 0.06 | 1670.7 ± 124.5 |
| PP-MFP- | 96% | PP | 4% | — | — | 4.13 ± 0.06 | 742.7 ± 180.7 |
| 01# | | | | | | | |
| PP-MFP- | 96% | PP | — | 4% | — | 4.00 ± 0.06 | 1615.2 ± 62.9 |
| 04# | | | | | | | |
| PP-MFP- | 96% | PP | — | — | 4% | 4.13 ± 0.06 | 1603.3 ± 17.6 |

05#

It is again observed across all plastic samples with the addition of micro-sized foaming pellets masterbatch compositions that there is weight reduction ranging from approximately 9% to 13% relative to the control sample.

However, similar to the tensile strength test above, PP-MFP-01 #(i.e. masterbatch without amphiphilic stabilizing agents) shows a weaker mechanical performance, with less than 50% of flexural modulus retention. In comparison, PP-MFP-04 #and PP-MFP-05 #both showed over 95% retention of flexural modulus, displaying superior mechanical strengths and robustness.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of +10%, +5%, +1%, or +0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within +10%, +5%, +1%, or +0.5% of the average of the values.

1. A micro-sized foaming pellets masterbatch composition for fabrication of weight-reduced controlled micro-foaming plastic product, comprising:
a low-melting point thermoplastic carrier resin with melting point lower than 125° C.;
a bi-component micro-foaming agent comprising a gas carrier and an acid carrier;
an amphiphilic stabilizing agent selected from a fatty acid-modified salt, glycerol monostearate, or a combination thereof; and
an adsorbing dispersant,
wherein the micro-sized foaming pellets masterbatch composition is configured to be integrated into a weight-reduced controlled micro-foaming plastic product by mixing with a base plastic resin to create a foamed plastic by extrusion and injection molding;
wherein the weight ratio of gas carrier in the bi-component micro-foaming agent is 3% to 15%;
wherein the weight ratio of acid carrier in the bi-component micro-foaming agent is 15% to 50%;
wherein 90% of the pores of the weight-reduced controlled micro-foaming plastic product has a pore size of less than 150 μm;
wherein the weight of the weight-reduced controlled micro-foaming plastic product is at least 9% lower than a plastic product prepared without integrating the micro-sized foaming pellets masterbatch composition;
wherein at least 75% of the tensile strength of a plastic product prepared without integrating the micro-sized foaming pellets masterbatch composition is retained in the weight-reduced controlled micro-foaming plastic product; and
wherein at least 95% of the flexural modulus of a plastic product prepared without integrating the micro-sized foaming pellets masterbatch composition is retained in the weight-reduced controlled micro-foaming plastic product.

2. The micro-sized foaming pellets masterbatch composition of claim 1, wherein the low melting point thermoplastic carrier resin is selected from linear low-density polyethylene (LLDPE), low-density polyethylene (LDPE), ethylene methyl acrylate (EMA), ethylene vinyl acetate (EVA), or any combinations thereof.

3. The micro-sized foaming pellets masterbatch composition of claim 1, wherein the gas carrier of the bi-component micro-foaming agent is selected from sodium bicarbonate, ammonium carbonate, or a combination thereof.

4. The micro-sized foaming pellets masterbatch composition of claim 1, wherein the acid carrier of the bi-component micro-foaming agent is selected from citric acid, sodium dihydrogen citrate, sodium dihydrogen phosphate, or any combinations thereof.

5. The micro-sized foaming pellets masterbatch composition of claim 1, wherein the fatty acid-modified calcium carbonate is selected from oleic acid-modified calcium carbonate, stearyl phosphate-modified calcium carbonate, palmitic acid-modified calcium carbonate, stearic acid-modified calcium carbonate, or any combinations thereof.

6. The micro-sized foaming pellets masterbatch composition of claim 1, wherein the adsorbing dispersant is mineral oil comprising hydrocarbons with 20 to 30 carbon atoms.

7. The micro-sized foaming pellets masterbatch composition of claim 1, wherein the content of the low-melting point thermoplastic carrier resin ranges from 50 wt % to 90 wt %.

8. The micro-sized foaming pellets masterbatch composition of claim 1, wherein the content of the bi-component micro-foaming agent ranges from 10 wt % to 50 wt %.

9. The micro-sized foaming pellets masterbatch composition of claim 1, wherein the content of the amphiphilic stabilizing agent ranges from 1 wt % to 10 wt %.

10. The micro-sized foaming pellets masterbatch composition of claim 1, wherein the content of the dispersant ranges from 0.5 wt % to 10 wt %.

11. A method of preparing a weight-reduced controlled micro-foaming plastic product with the micro-sized foaming pellets masterbatch composition of claim 1, comprising:
mixing a low-melting point thermoplastic carrier resin, a bi-component micro-foaming agent, an amphiphilic stabilizing agent and a dispersant to form a first mixture;
subjecting the first mixture to extrusion and pelletizing the first mixture at a temperature of 60° C. to 150° C. to form the micro-sized foaming pellets masterbatch composition;
mixing the micro-sized foaming pellets masterbatch composition with base plastic resins at a weight ratio of 1:99 to 4:96 to form a second mixture; and
subjecting the second mixture to extrusion and molding the second mixture at a temperature of 220° C. to 300° C. to form the weight-reduced controlled micro-foaming plastic product.

12. The method of claim 11, wherein subjecting the first mixture to extrusion and pellitizing the first mixture comprises extrusion under a screw rotation speed of 140 rpm to 160 rpm.

13. The method of claim 11, wherein subjecting the second mixture to extrusion and molding the second mixture comprises extrusion under a screw rotation speed of 90 rpm to 110 rpm.

14. The method of claim 11, wherein the micro-sized foaming pellets masterbatch composition comprises:
60 wt % to 88 wt % of the low-melting point thermoplastic carrier resin;
20 wt % to 40 wt % of the micro-foaming agent;
1 wt % to 3 wt % of the adsorbing dispersant; and
0.5 wt % to 9 wt % of the amphiphilic stabilizing agent.

15. The method of claim 11, wherein the low-melting point thermoplastic carrier resin is selected from linear low-density polyethylene (LLDPE), low-density polyethylene (LDPE), ethylene methyl acrylate (EMA), ethylene vinyl acetate (EVA), or any combinations thereof.

16. The method of claim 11, wherein the gas carrier of the bi-component micro-foaming agent is selected from sodium bicarbonate, ammonium carbonate, or a combination thereof.

17. The method of claim 11, wherein the acid carrier of the bi-component micro-foaming agent is selected from citric acid, sodium dihydrogen citrate, sodium dihydrogen phosphate, or any combinations thereof.

18. The method of claim 11, wherein the fatty acid-modified calcium carbonate is selected from oleic acid-modified calcium carbonate, stearyl phosphate-modified calcium carbonate, palmitic acid-modified calcium carbonate, stearic acid-modified calcium carbonate, or any combinations thereof.

19. The method of claim 11, wherein the adsorbing dispersant is mineral oil comprising hydrocarbons with 20 to 30 carbon atoms.

20. The method of claim 11, wherein the base plastic resins is selected from polyethylene (PE), polypropylene (PP), polyethylene terephthalate (PET), polyamide 6 (PA6), acrylonitrile butadiene styrene (ABS), polycarbonate (PC), or any combinations thereof.
